(19) United States
(12) Patent Application Publication
(10) Pub. No.: US 2015/0195089 A1
(43) Pub. Date: Jul. 9, 2015

(54) DATA SCRAMBLE DEVICE, SECURITY DEVICE, SECURITY SYSTEM, AND DATA SCRAMBLE METHOD

(71) Applicants: FUJITSU LIMITED, Kawasaki-shi (JP); FUJITSU SEMICONDUCTOR LIMITED, Yokohama-shi (JP)

(72) Inventor: Jun YAJIMA, Kawasaki (JP)

(73) Assignees: FIJITSU LIMITED, Kawasaki-shi (JP); FUJITSU SEMICONDUCTOR LIMITED, Yokohama-shi (JP)

(21) Appl. No.: 14/587,466

(22) Filed: Dec. 31, 2014

(30) Foreign Application Priority Data
Jan. 7, 2014 (JP) 2014-000908

(51) Int. Cl. H04L 9/08; G06F 7/58

(52) U.S. Cl. CPC H04L 9/0869; G06F 7/582; H04L 2209/24

(57) ABSTRACT

A data scramble device includes an intermediate key generation unit configured to generate intermediate keys from random numbers, and an extended key generation unit configured to generate an extended key from intermediate keys generated by the intermediate key generation unit. Further, the data scramble device includes a scramble arithmetic operation unit configured to generate scramble data by performing a scramble arithmetic operation of target data and an extended key generated by the extended key generation unit.

### CROSS-REFERENCE TO RELATED APPLICATION

This application is based upon and claims the benefit of priority of the prior Japanese Patent Application No.2014-000908, filed on Jan. 7, 2014, the entire contents of which are incorporated herein by reference.

### FIELD

The present invention relates to a data scramble device, a security device, a security system, and a data scramble method.

### BACKGROUND

A technique for adding a data encryption function to a embedded equipment is known in order to prevent data stored in a storage (external storage device) of the embedded equipment from information leakage by the theft of the data. Further, a technique for arranging an encryption accelerator having an encryption function is known in order to prevent the load due to the encryption of data on a CPU (Central Processing Unit, hereinafter, also referred to as a host device) of the embedded equipment from increasing. It is possible to encrypt data without increasing the load on the host device, by adding an encryption accelerator to the embedded equipment.

Further, a technique for encrypting the data transmitted and received between the host device and the encryption accelerator is known in order prevent information from being leaked due to theft of data transmitted and received via a wire between the host device and the encryption accelerator. However, if the data transmitted and received between the host device and the encryption accelerator is encrypted, the load on the host device may increase, which is the encryption on the host side. In other words, if encryption is performed on the host side when transmitting data to the encryption accelerator in order to perform encryption at a high speed, the role of the accelerator is made less significant, and it is not practical to encrypt data on the wire. In order to prevent the theft of the data transmitted and received between the host device and the encryption accelerator while maintaining the load on the host device to a minimum, a technique for performing a scramble arithmetic operation on the data between the host device and the encryption accelerator by using an authentication code is known. The scramble arithmetic operation referred to here is an exclusive OR operation. It is possible to prevent the theft of the data between the host device and the encryption accelerator while keeping the load on the host device to a minimum, by performing the scramble arithmetic operation on the data transmitted and received between the host device and the encryption accelerator.

### RELATED DOCUMENTS

[Patent Document 1] Japanese Laid Open Patent Document No. 2013-25374

[Patent Document 2] Japanese Laid Open Patent Document No. 2002-91295

### SUMMARY

According to a first aspect of the embodiment, a data scramble device includes: an intermediate key generation unit configured to generate intermediate keys from random numbers; an extended key generation unit configured to generate an extended key from intermediate keys generated by the intermediate key generation unit; and a scramble arithmetic operation unit configured to generate scramble data by performing a scramble arithmetic operation of target data and an extended key generated by the extended key generation unit.

The object and advantages of the embodiments will be realized and attained by means of the elements and combination particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a block diagram of embedded equipment according to an embodiment;

FIG. 2A is a function block diagram of the host device;

FIG. 2B is a function block diagram of the encryption accelerator;

FIG. 3 is an internal circuit block diagram of the intermediate key generation unit of the host device;

FIG. 4 is a circuit block diagram of the extended key generation unit of the host device;

FIG. 5A is a diagram illustrating a selection algorithm of the intermediate key selector;

FIG. 5B is a diagram illustrating the first intermediate key selection table;

FIG. 5C is a diagram illustrating the second intermediate key selection table;

FIG. 6 is an internal circuit block diagram of the intermediate key generation unit of the encryption accelerator;

FIG. 7 is a circuit block diagram of the extended key generation unit of the encryption accelerator;

FIG. 8 is a flowchart illustrating the encryption processing;

FIG. 9A is a diagram illustrating another selection algorithm;

FIG. 9B is a diagram illustrating a first intermediate key selection table used in the selection algorithm illustrated in FIG. 9A; and

FIG. 9C is a diagram illustrating a second intermediate key selection table used in the selection algorithm illustrated in FIG. 9A.

### DESCRIPTION OF EMBODIMENTS

Hereinafter, with reference to the drawings, a data scramble device, a security device, a security system, and a data scramble method according the present invention are explained. However, it should be noted that the technical scope of the present invention is not limited to embodiments below but encompasses the inventions and equivalents thereof described in the claims.

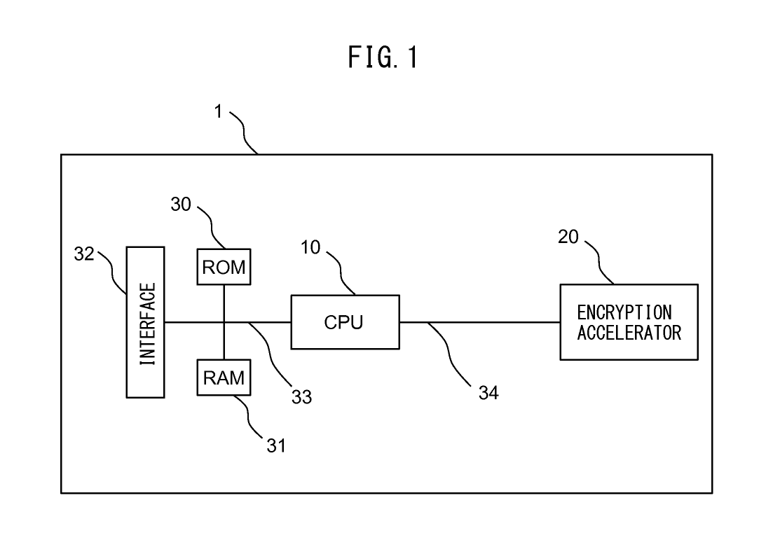

FIG. 1 is a block diagram of embedded equipment according to an embodiment.

Embedded equipment 1 has a host device 1, an encryption accelerator 20, a ROM (Read Only Memory) 30, a RAM (Random Access Memory) 31, and an interface 32. The host device 10, the ROM 30, the RAM 31, and the interface 32 are connected to one another via a bus line 33. The host device 10 and the encryption accelerator 20 are connected via a serial line 34.

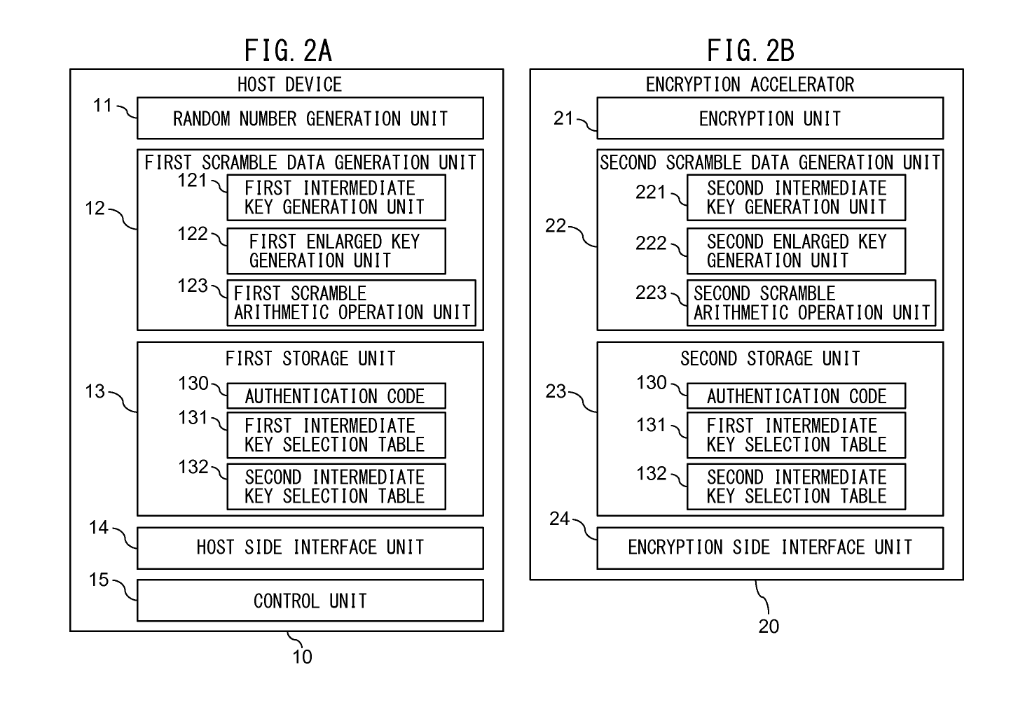

FIG. 2A is a function block diagram of the host device 10 and FIG. 2B is a function block diagram of the encryption accelerator 20.

The host device 10 has a random number generation unit 11, a first scramble data generation unit 12, a first storage unit 13, a host side interface unit 14, and a control unit 15. The first storage unit 13 has a 16-byte authentication code 130, a first intermediate key selection table 131, and a second intermediate key selection table 132.

The encryption accelerator 20 has an encryption unit 21, a second scramble data generation unit 22, a second storage unit 23, and an encryption side interface unit 24. The second storage unit 23 stores the authentication code 130, which is the same as the authentication code stored in the first storage unit 13. Further, the second storage unit 23 stores the first intermediate key selection table 131 and the second intermediate key selection table 132, which are the same as the first intermediate key selection table 131 and the second intermediate key selection table 132 stored in the first storage unit 13.

The random number generation unit 11 generates a 16-byte pseudo random number based on instructions of the control unit 15 and outputs the generated random number to the first scramble data generation unit 12 and the first storage unit 13.

The first scramble data generation unit 12 has a first intermediate key generation unit 121, a first extended key generation unit 122, and a first scramble arithmetic operation unit 123.

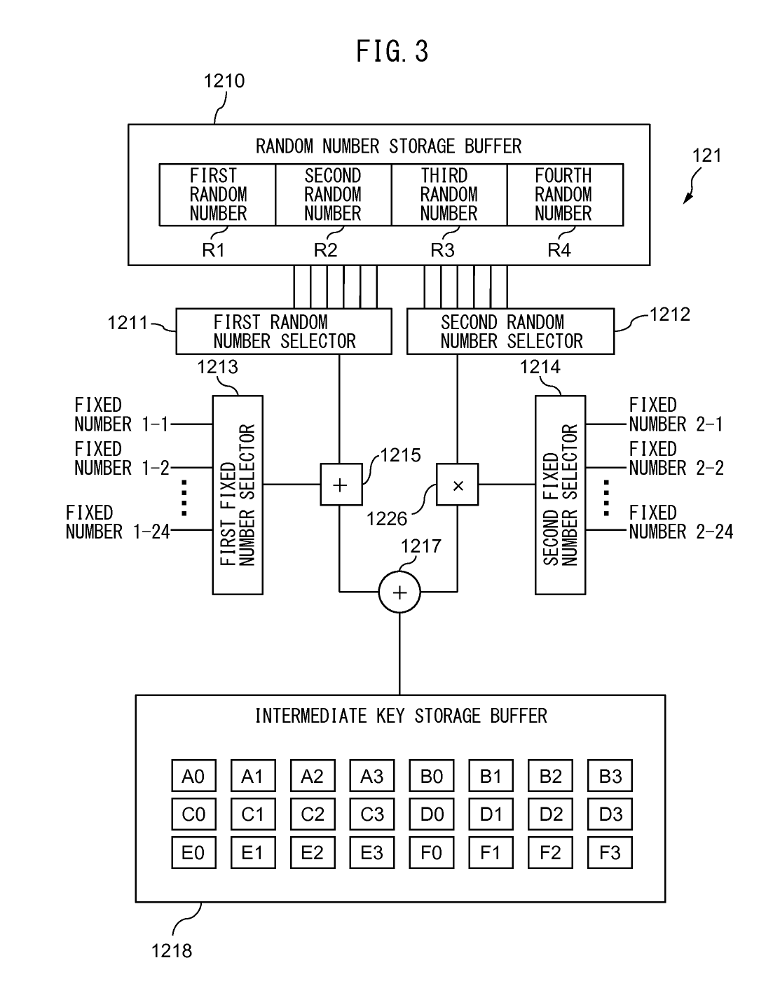

FIG. 3 is an internal circuit block diagram of the first intermediate key generation unit 121.

The first intermediate key generation unit 121 has a random number storage buffer 1210, a first random number selector 1211, a second random number selector 1212, a first fixed number selector 1213, and a second fixed number selector 1214. The first intermediate key generation unit 121 further has an adder 1215, a multiplier 1216, an exclusive OR unit 1217, and an intermediate key storage buffer 1218.

The random number storage buffer 1210 stores a 16-byte random number generated by the random number generation unit 11. The first random number selector 1211 and the second random number selector 1212 sequentially select four bytes each time of the 16-byte random number stored in the random number storage buffer 1210. First, the first random number selector 1211 and the second random number selector 1212 select a first random number R1, which is the first 4-byte random number. Next, the first random number selector 1211 and the second random number selector 1212 select a second random number R2, which is the next 4-byte random number. Next, the first random number selector 1211 and the second random number selector 1212 select a third random number R3, which is the next 4-byte random number. Then, the first random number selector 1211 and the second random number selector 1212 select a fourth random number R4, which is the last 4-byte random number. After selecting the fourth random number R4, the first random number selector 1211 and the second random number selector 1211 select the first random number R1. Then, the first random number selector 1211 and the second random number selector 1212 sequentially select the first random number R1 to the fourth random number R4.

The first fixed number selector 1213 sequentially selects 24 fixed numbers that are different from one another, i.e., a first-1 fixed number to a first-24 fixed number. After lastly selecting the first-24 fixed number, the first fixed number selector 1213 exits the selection processing. The second fixed number selector 1214 sequentially selects 24 fixed numbers that are different from one another, i.e., a second-1 fixed number to a second-24 fixed number. After lastly selecting the second-24 fixed number, the second fixed number selector 1214 exits the selection processing.

The adder 1215 generates 4-byte first arithmetic operation data by adding the 4-byte random number selected by the first random number selector 1211 and the fixed number selected by the first fixed number selector 1213. First, the adder 1215 generates first-1 arithmetic operation data by adding the first random number R1 selected by the first random number selector 1211 and the first-1 fixed number selected by the first fixed number selector 1213. Next, the adder 1215 generates first-2 arithmetic operation data by adding the second random number R2 selected by the first random number selector 1211 and the first-2 fixed number selected by the first fixed number selector 1213. Then, the adder 1215 repeats the processing to add the random number selected by the first random number selector 1211 and the fixed number selected by the first fixed number selector 1213. After generating first-24 arithmetic operation data by adding the fourth random number R4 selected by the first random number selector 1211 and the first-24 fixed number selected by the first fixed number selector 1213, the adder 1215 exits the addition processing.

The multiplier 1216 generates 4-byte second arithmetic operation data by multiplying the 4-byte random number selected by the second random number selector 1212 and the fixed number selected by the second fixed number selector 1214. First, the multiplier 1216 generates second-1 arithmetic operation data by multiplying the first random number R1 selected by the second random number selector 1212 and the second-1 fixed number selected by the second fixed number selector 1214. Next, the multiplier 1216 generates second-2 arithmetic operation data 2-2 by multiplying the second random number R2 selected by the second random number selector 1212 and the second-2 fixed number selected by the second fixed number selector 1214. Then, the multiplier 1216 repeats the processing to multiply the random number selected by the second random number selector 1212 and the fixed number selected by the second fixed number selector 1214. After generating second-24 arithmetic operation data by multiplying the fourth random number R4 selected by the second random number selector 1212 and the second-24 fixed number selected by the second fixed number selector 1214, the multiplier 1216 exits the multiplication processing.

The exclusive OR unit 1217 performs an exclusive OR (hereinafter, also referred to as XOR) operation of the first arithmetic operation data obtained by the adder 1215 performing an arithmetic operation and the second arithmetic operation data obtained by the multiplier 1216 performing an arithmetic operation and generates a 4-byte intermediate key. The exclusive OR unit 1217 stores the generated intermediate key in the intermediate key storage buffer 1218. First, the exclusive OR unit 1217 generates a first intermediate key AO by performing an XOR operation of the first-1 arithmetic operation data obtained by the adder 1215 performing an arithmetic operation and the second-1 arithmetic operation data obtained by the multiplier 1216 performing an arithmetic operation, and stores the first intermediate key A0 in the intermediate key storage buffer 1218. Next, the exclusive OR unit 1217 generates a second intermediate key A1 by performing an XOR operation of the first-2 arithmetic operation data obtained by the adder 1215 performing an arithmetic operation and the second-2 arithmetic operation data obtained by the multiplier 1216 performing an arithmetic operation, and stores the second intermediate key A1 in the intermediate key storage buffer 1218. Then, the exclusive OR unit 1217 repeats the processing to perform an XOR operation of the first arithmetic operation data obtained by the adder 1215 performing an arithmetic operation and the second arithmetic operation data obtained by the multiplier 1216 performing an arithmetic operation. The generated intermediate keys are stored as the first and second intermediate keys A1 and A1 and third and fourth intermediate keys A2 and A3, fifth to eighth intermediate keys B0 to B3, ninth to twelfth intermediate keys C0 to C3, thirteenth to sixteenth intermediate keys D0 to D3, seventeenth to twentieth intermediate keys E0 to E3, and twenty-first to twenty-fourth intermediate keys F0 to F3. After generating the twenty-fourth intermediate key F3 by performing an XOR operation of the first-24 arithmetic operation data obtained by the adder 1215 performing an arithmetic operation and the second-24 arithmetic operation data obtained by the multiplier 1216 performing an arithmetic operation, the exclusive OR unit 1217 exits the multiplication processing.

The intermediate key storage buffer 1218 sequentially stores the first to fourth intermediate keys A0 to A3, the fifth to eighth intermediate keys B0 to B3, the ninth to twelfth intermediate keys C0 to C3, the thirteenth to sixteenth intermediate keys D0 to D3, the seventeenth to twentieth intermediate keys E0 to E3, and the twenty-first to twenty-fourth intermediate keys F0 to F3.

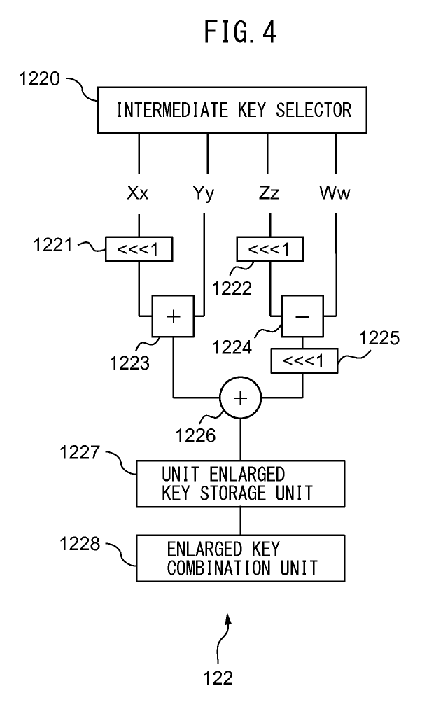

FIG. 4 is a circuit block diagram of the first extended key generation unit 122.

The first extended key generation unit 122 has an intermediate key selector 1220, a first bit rotation unit 1221, a second bit rotation unit 1222, a first addition unit 1223, a subtraction unit 1224, a third bit rotation unit 1225, and a second addition unit 1226. The first extended key generation unit 122 further has a unit extended key storage unit 1227 and an extended key combination unit 1228.

The intermediate key selector 1220 selects four intermediate keys, i.e., a first selection key Xx, a second selection key Yy, a third selection key Zz, and a fourth selection key Ww, from 24 intermediate keys stored in the intermediate key storage buffer 1218 based on a predetermined algorithm. The intermediate key selector 1220 repeats the process of selecting four intermediate keys from the 24 intermediate keys stored in the intermediate key storage buffer 1218 512 times by using the first intermediate key selection table 131 and the second intermediate key selection table 132 stored in the first storage unit 13.

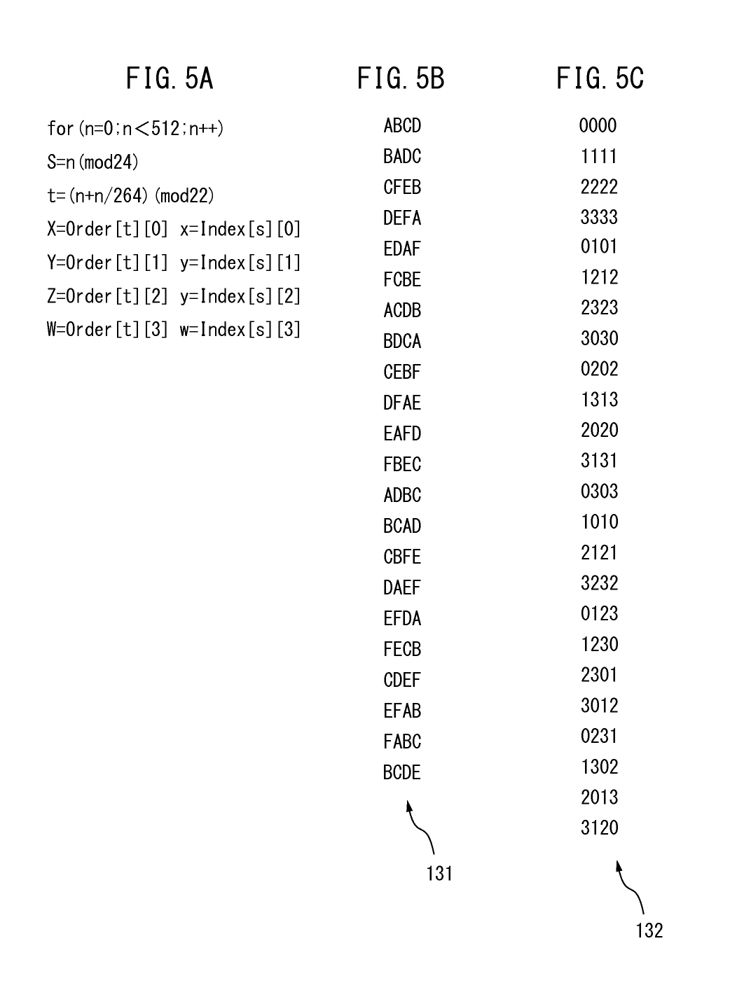

FIG. 5A is a diagram illustrating a selection algorithm of the intermediate key selector 1220, FIG. 5B is a diagram illustrating the first intermediate key selection table 131, and FIG. 5C is a diagram illustrating the second intermediate key selection table 132.

The first intermediate key selection table 131 is a table in which alphabets A to F are arranged in 22 rows, from a zeroth row to a twenty-first row, and in four columns, from a zeroth column to a third column. For example, “A” is arranged in the zeroth row and the zeroth column of the first intermediate key selection table 131, “F” is arranged in the fourth row and the third column, and “E” is arranged in the twenty-first row and the third column.

The second intermediate key selection table 132 is a table in which numerical values 0 to 3 are arranged in 24 rows, from a zeroth row to a twenty-third row, and in four columns, from a zeroth column to a third column. For example, “0” is arranged in the zeroth row and the zeroth column of the second intermediate key selection table 132, “1” is arranged in the fourth row and the third column, and “0” is arranged in the twenty-third row and the third column.

The intermediate key selector 1220 sequentially selects four intermediate keys from the 24 intermediate keys stored in the intermediate key storage buffer 1218 by using the first intermediate key selection table 131 and the second intermediate key selection table 132 based on the algorithm illustrated in FIG. 5A. In FIG. 5A, X indicates the alphabet portion of the first selection key and x indicates the numeral portion of the first selection key, Y indicates the alphabet portion of the second selection key and y indicates the numeral portion of the second selection key, and Z indicates the alphabet portion of the third selection key and z indicates the numeral portion of the third selection key. W indicates the alphabet portion of the fourth selection key and w indicates the numeral portion of the fourth selection key.

Further, in FIG. 5A, “t” indicates the row of the first intermediate key selection table 131 and “s” indicates the row of the second intermediate key selection table 132. “Order [t][0]” indicates the alphabet in the tth row and the zeroth column of the first intermediate key selection table 131 and “Index [s][0]” indicates the numeral in the sth row and the zeroth column of the second intermediate key selection table 132. “Order [t][1]” indicates the alphabet in the tth row and the first column of the first intermediate key selection table 131 and “Index [s][1]” indicates the numeral in the sth row and the first column of the second intermediate key selection table 132. “Order [t][2]” indicates the alphabet in the tth row and the second column of the first intermediate key selection table 131 and “Index [s][2]” indicates the numeral in the sth row and the second column of the second intermediate key selection table 132. “Order [t][3]” indicates the alphabet in the tth row and the third column of the first intermediate key selection table 131 and “Index [s][3]” indicates the numeral in the sth row and the third column of the second intermediate key selection table 132.

In the first-time selection processing, the intermediate key selector 1220 selects the first intermediate key A0 as the first selection key Xx, selects the fifth intermediate key B0 as the second selection key Yy, selects the ninth intermediate key C0 as the third selection key Zz, and selects the thirteenth intermediate key D0 as the fourth selection key Ww.

In the second-time selection processing, the intermediate key selector 1220 selects the sixth intermediate key B1 as the first selection key Xx, selects the second intermediate key A1 as the second selection key Yy, selects the fourteenth intermediate key D1 as the third selection key Zz, and selects the tenth intermediate key C1 as the fourth selection key Ww. In this manner, until the 264th-time selection processing is completed, four selection keys are sequentially selected by increasing the row number that is selected one by one in the first intermediate key selection table 131 and the second intermediate key selection table 132.

In the 265th-time selection processing, the first row is selected, which is a row whose row number is increased by two from the row of the first intermediate key selection table 131 selected in the 264th-time selection processing, i.e., the twenty-third row. Then, until the 512th-time selection processing is completed, four selection keys are sequentially selected by increasing the row number that is selected one by one in the first intermediate key selection table 131 and the second intermediate key selection table 132.

The permutations of alphabets A to F arranged in each row of the zeroth row to the twenty-first row of the first intermediate selection table 131 are different from one another. Further, the permutations of numerical values 0 to 3 arranged in each row of the zeroth row to the twenty-third row of the second intermediate key selection table 132 are different from one another. The algorithm illustrated in FIG. 5A selects four intermediate keys that are different for each of the 512 pieces of processing, the number of pieces of processing being greater than 264, which is the least common multiple of 22, which is the number of rows of the first intermediate selection table 131, and 24, which is the number of rows of the second intermediate selection table 132.

The first bit rotation unit 1221 generates first bit rotation data by rotating the first selection key Xx one bit to the left. The second bit rotation unit 1222 generates second bit rotation data by rotating the third selection key Zz one bit to the left. The first addition unit 1223 generates first addition data by adding the first bit rotation data generated by the first bit rotation unit 1221 and the second selection key Yy. The subtraction unit 1224 generates subtraction data by adding the second bit rotation data generated by the second bit rotation unit 1222 and the fourth selection key Ww. The third bit rotation unit 1225 generates third bit rotation data by rotating the subtraction data generated by the subtraction unit 1224 one bit to the left. The second addition unit 1226 generates a four-byte unit extended key by adding the first addition data generated by the first addition unit 1223 and the third bit rotation data generated by the third bit rotation unit 1225.

The first bit rotation unit 1221, the second bit rotation unit 1222, the first addition unit 1223, the subtraction unit 1224, the third bit rotation unit 1225, and the second addition unit 1226 generate a unit extended key each time the intermediate key selector 1220 selects four intermediate keys. Since the intermediate key selector 1220 selects four intermediate keys 512 times, 512 unit extended keys from a first unit extended key to a 512th unit extended key are generated. The first unit extended key to the 512th unit extended key are different from one another, since an arithmetic operation is performed by using four intermediate keys different from other four intermediate keys for each piece of the processing.

The unit extended key storage unit 1227 sequentially stores the 512 unit extended keys from the first unit extended key to the 512th unit extended key generated by the second addition unit 1226. The extended key combination unit 1228 combines an extended key having a data length of 2,048 bytes by combining the first unit extended key to the 512 unit extended key each having four bytes stored by the unit extended key storage unit 1227.

The first scramble arithmetic operation unit 123 scrambles target data by performing an XOR operation of key data and the target data. For example, the first scramble arithmetic operation unit 123 generates scramble data B by scrambling target data A by performing an XOR operation of key data X and the target data A. On the contrary, the first scramble arithmetic operation unit 123 decrypts the target data A by performing an XOR operation of the scramble data B and the key data X.

The first scramble arithmetic operation unit 123 generates 16-byte first scramble data by performing an XOR operation of a 16-byte random number generated by the random number generation unit 11 and the 16-byte authentication code 130 stored in the first storage unit 13. Further, the first scramble arithmetic operation unit 123 generates 2,048-byte second scramble data by performing an XOR operation of 2,048-byte target data and a 2,048-byte extended key.

The host side interface unit 14 transmits a signal indicating the data generated by the first scramble data generation unit 12 to the encryption side interface unit 24 via the serial line 34. Further, the host side interface unit 14 receives a signal transmitted from the encryption side interface unit 24 via the serial line 34.

The host side interface unit 14 transmits a signal indicating the first scramble data and the second scramble data generated by the first scramble arithmetic operation unit 123 to the encryption side interface unit 24. Further, the host side interface unit 14 receives a signal indicating the encryption target data encrypted by the encryption unit 21 from the encryption side interface unit 24.

The control unit 15 controls the operation of the devices, such as the host device 10 and the encryption accelerator 20, which are mounted on the embedded equipment 1 in accordance with computer programs stored in the ROM.

The encryption unit 21 performs encryption processing and decryption processing by using the secret key cryptography, such as DES and AES, and the public key cryptography, such as RSA.

The second scramble data generation unit 22 has a second intermediate key generation unit 221, a second extended key generation unit 222, and a second scramble arithmetic operation unit 223. The second intermediate key generation unit 221, the second extended key generation unit 222, and the second scramble arithmetic operation unit 223 have the same configuration and function of the first intermediate key generation unit 121, the first extended key generation unit 122, and the first scramble arithmetic operation unit 123, respectively. The second scramble data generation unit 22 determines whether or not a signal indicating the second scramble data has been received from the host device 10. When it is determined that a signal indicating the second scramble data has been received from the host device 10, the second scramble data generation unit 22 starts intermediate key generation processing.

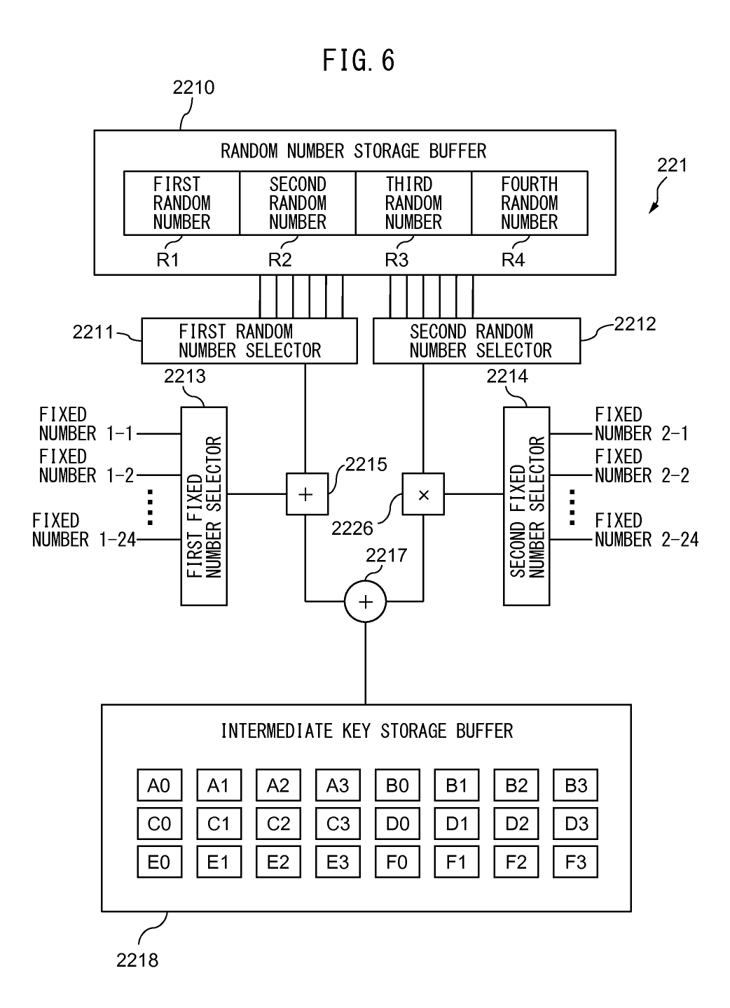

FIG. 6 is an internal circuit block diagram of the second intermediate key generation unit 221.

The second intermediate key generation unit 221 has a random number storage buffer 2210, a first random number selector 2211, a second random number selector 2212, a first fixed number selector 2213, and a second fixed number selector 2214. The second intermediate key generation unit 221 further has an adder 2215, a multiplier 2216, an exclusive OR unit 2217, and an intermediate key storage buffer 2218.

The random number storage buffer 2210 stores 16-byte random numbers. The first random number selector 2211 and the second random number selector 2212 sequentially select the 16-byte random numbers stored in the random number storage buffer 2210 in units of four bytes.

The first fixed number selector 2213 sequentially selects 24 fixed numbers, i.e., the first-1 fixed number to the first-24 fixed number that are different from one another, and the second fixed number selector 2214 sequentially selects 24 fixed numbers, i.e., the second-1 fixed number to the second-24 fixed number that are different from one another. Each of the adder 2215, the multiplier 2216, and the exclusive OR unit 2217 performs an arithmetic operation of a selected four-byte random number and a fixed number.

The intermediate key storage buffer 2218 sequentially stores the first to fourth intermediate keys A0 to A3, the fifth to eighth intermediate keys B0 to B3, the ninth to twelfth intermediate keys C0 to C3, the thirteenth to sixteenth intermediate keys D0 to D3, the seventeenth to twentieth intermediate keys E0 to E3, and the twenty-first to twenty-fourth intermediate keys F0 to F3.

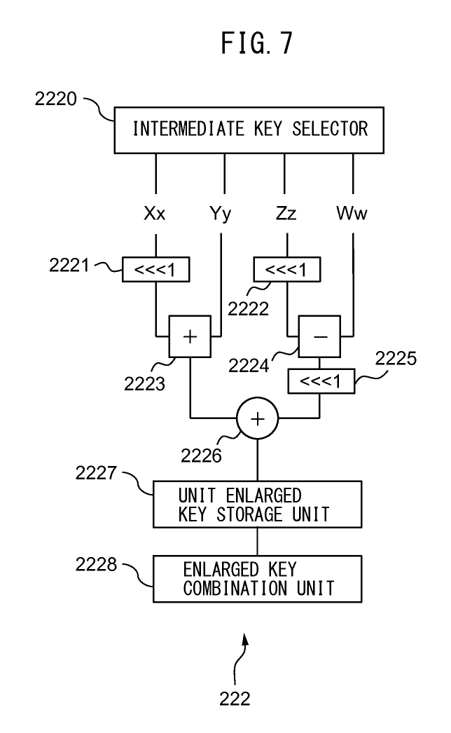

FIG. 7 is a circuit block diagram of the second extended key generation unit 222.

The second extended key generation unit 222 has an intermediate key selector 2220, a first bit rotation unit 2221, a second bit rotation unit 2222, a first addition unit 2223, a subtraction unit 2224, a third bit rotation unit 2225, and a second addition unit 2226. The second extended key generation unit 222 further has a unit extended key storage unit 2227 and an extended key combination unit 2228.

The intermediate key selector 2220 selects for selection keys 512 times based on the algorithm in FIG. 5A by using the first intermediate key selection table 131 and the second intermediate key selection table 132.

The first bit rotation unit 2221, the second bit rotation unit 2222, the first addition unit 2223, the subtraction unit 2224, the third bit rotation unit 2225, and the second addition unit 2226 generate a unit extended key each time the intermediate key selector 2220 selects four intermediate keys. Since the intermediate key selector 2220 selects four intermediate keys 512 times, 512 unit extended keys, i.e., a first unit extended key to a 512th unit extended key, are generated.

The unit extended key storage unit 2227 sequentially stores the 512 unit extended keys, from the first unit extended key to the 512th unit extended key, generated by the second addition unit 2226. The extended key combination unit 2228 combines an extended key having a data length of 2,048 bytes by combining the first unit extended key to the 512th unit extended key each having a data length of four bytes stored by the unit extended key storage unit 2227.

The second scramble arithmetic operation unit 223 scrambles encryption target data by performing an XOR operation of key data and the encryption target data. The first scramble arithmetic operation unit 123 decrypts a random number by performing an XOR operation of the 16-byte first scramble data transmitted from the host side interface unit 14 and the 16-byte authentication code stored in the second storage unit 23. Further, the second scramble arithmetic operation unit 223 decrypts encryption target data by performing an XOR operation of the 2,048-byte second scramble data transmitted from the host side interface unit 14 and the 2,048-byte extended key.

The encryption side interface unit 24 transmits a signal indicating the encryption target data that has been encrypted by the encryption unit 21 to the host side interface unit 14 via the serial line 34. Further, the encryption side interface unit 24 receives a signal indicating the first scramble data and the second scramble data transmitted from the host side interface unit 14 via the serial line 34.

In paragraphs [0040] and [0057], the method for combining the 2,048-byte extended key from the unit extended keys and for storing the 2,048-byte extended key is described, but the extended key storage unit does not necessarily require 2,048 bytes. For example, a method may be adopted, in which the size of the extended key storage unit is set to the same size of the unit key and each time one unit extended key is generated, the unit extended key is stored, and after performing a scramble arithmetic operation of the unit key and data of the same size as that of the unit key, the next unit key is stored in the same region.

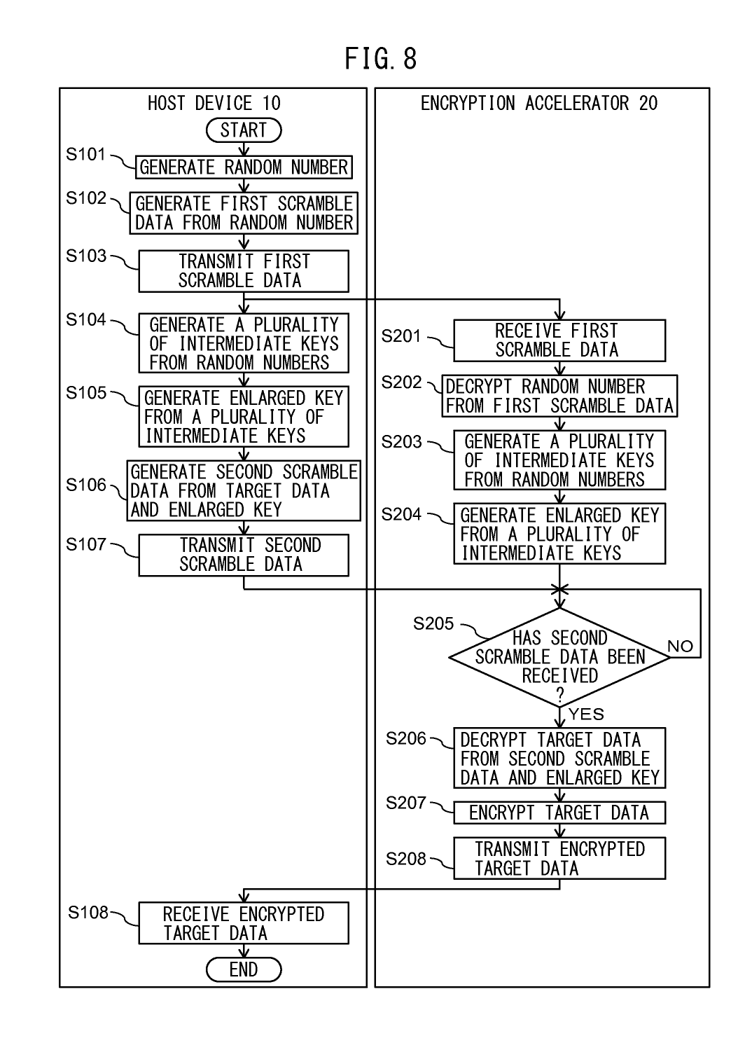

FIG. 8 is a flowchart illustrating the processing of the host device 10 to encrypt encryption target data by using the encryption accelerator 20.

First, at step S101, the random generation unit 11 generates a random number.

Next, at step S102, the first scramble arithmetic operation unit 123 generates first scramble data by performing an XOR operation of the random number generated by the random number generation unit 11 and the authentication code stored in the first storage unit 13.

Next, at step S103, the host side interface unit 14 transmits the first scramble data generated by the first scramble arithmetic operation unit 123 to the encryption side interface unit 24. Next, the processing proceeds to steps S104 and S201.

When the processing proceeds to step S104, the first intermediate key generation unit 121 generates 24 intermediate keys from the random numbers generated by the random number generation unit 11.

Next, at step S105, the first extended key generation unit 122 generates an extended key from the 24 intermediate keys generated by the first intermediate key generation unit 121.

Next, at step S106, the first scramble arithmetic operation unit 123 generates second scramble data by performing an XOR operation of the extended key generated by the first extended key generation unit 122 and encryption target data.

Next, at step S107, the host side interface unit 14 transmits the second scramble data generated by the first scramble arithmetic operation unit 123 to the encryption side interface unit 24. Next, the processing proceeds to step S205.

When the processing proceeds to step S201, the encryption side interface unit 24 receives the first scramble data transmitted by the host side interface unit 14.

Next, at step S202, the second scramble arithmetic operation unit 223 decrypts the random numbers from the first scramble data received by the encryption side interface unit 24.

Next, at step S203, the second intermediate key generation unit 221 generates 24 intermediate keys from the random numbers decrypted by the second scramble arithmetic operation unit 223.

Next, at step S204, the second extended key generation unit 222 generates an extended key from the 24 intermediate keys generated by the second intermediate key generation unit 221.

Next, at step S205, the second scramble data generation unit 22 determines whether or not a signal indicating the second scramble data has been received from the host device 10. In the case where it is determined that the second scramble data has not been received from the host device 10, after a predetermined standby time elapses, the second scramble data generation unit 22 determines again whether or not the second scramble data has been received from the host device 10. If the second scramble data generation unit 22 determines that the signal indicating the second scramble data transmitted by the host side interface unit 14 at step S107 has been received by the encryption side interface unit 24, the processing proceeds to step S206.

When the processing proceeds to step S206, the second scramble arithmetic operation unit 223 decrypts the encryption target data by performing an XOR operation of the second scramble data received by the encryption side interface unit 24 and the extended key generated by the second extended key generation unit 222.

Next, at step S207, the encryption unit 21 encrypts the encryption target data decrypted by a scramble arithmetic operation unit 2123.

Next, at step S208, the encryption side interface unit 24 transmits the encryption target data encrypted by an encryption unit 2114 to the host side interface unit 14.

Next, at step S108, the host side interface unit 14 receives the encrypted encryption target data from the encryption side interface unit 24.

In the embedded equipment 1, encryption target data is scrambled by using the extended key generated from a plurality of intermediate keys generated from random numbers, and therefore, it is not easy to steal the encryption target data that is transmitted from the host device 10 to the encryption accelerator 20. The extended key is data having 2,048 bytes or less and which does not have periodicity, and therefore, even if about 16 bytes of the extended key is leaked, it is unlikely that all the data is stolen.

Further, in the embedded equipment 1, the encryption target data that is transmitted from the host device 10 to the encryption accelerator 20 is scrambled without being encrypted, and therefore, encryption processing is not performed in the host device 10 and the load on the host device 10 can be reduced. Further, if the pseudo random number generated by the random number generation unit 11 has 40 bytes or less, for example, 16 bytes, it is possible to generate the pseudo random number at a high speed.

In the embedded equipment 1, the intermediate key generation unit that generates intermediate keys has a simple configuration having a plurality of selectors, a single adder, a multiplier, and an exclusive OR unit, and therefore, it is possible to reduce the circuit scale of the intermediate key generation unit.

Further, in the embedded equipment 1, the arithmetic operation processing of the extended key generation unit to generate an extended key is bit rotation processing, addition processing, and subtraction processing, and therefore, it is possible to perform high-speed arithmetic operation processing.

In the embedded equipment 1, the random number generation unit 11 generates 16-byte pseudo random numbers, but if the data length is the same as that of the authentication code 130, it may also be possible to use a random number generator that generates pseudo random numbers whose data length is longer than 16 bytes or pseudo random numbers whose data length is shorter than 16 bytes. Alternatively, it may also be possible to use a random number generator that generates true random numbers, such as physical random numbers.

In the embedded equipment 1, four-byte intermediate keys are used, but it may also be possible to use intermediate keys whose data length is longer than four bytes or intermediate keys whose data length is shorter than four bytes. Further, in the embedded equipment 1, the single first intermediate key generation unit 121 is caused to operate 24 times to generate 24 intermediate keys, but it may also be possible to generate 24 intermediate keys by using a plurality of the first intermediate key generation units 121. For example, it may also be possible to generate 24 intermediate keys by causing the four first intermediate key generation units 121 to operate six times or to generate 24 intermediate keys by causing the six first intermediate key generation units 121 to operate four times. Furthermore, in the embedded equipment 1, an extended key is generated by using 24 intermediate keys, but it may also be possible to generate an extended key by using more than 24 intermediate keys or less than 24 intermediate keys.

In the embedded equipment 1, each of the first scramble arithmetic operation unit 123 and the second scramble arithmetic operation unit 223 scrambles target data by an XOR operation, but a configuration may be accepted in which target data is scrambled by another arithmetic operation, such as the four basic arithmetic operations. Further, it may also be possible to scramble target data by a combination of the XOR operation and the four basic arithmetic operations.

In the embedded equipment 1, 24 intermediate keys are selected based on the algorithm illustrated in FIG. 5A by using the first intermediate key selection table 131 and the second intermediate key selection table 132, but it may also be possible to use another algorithm.

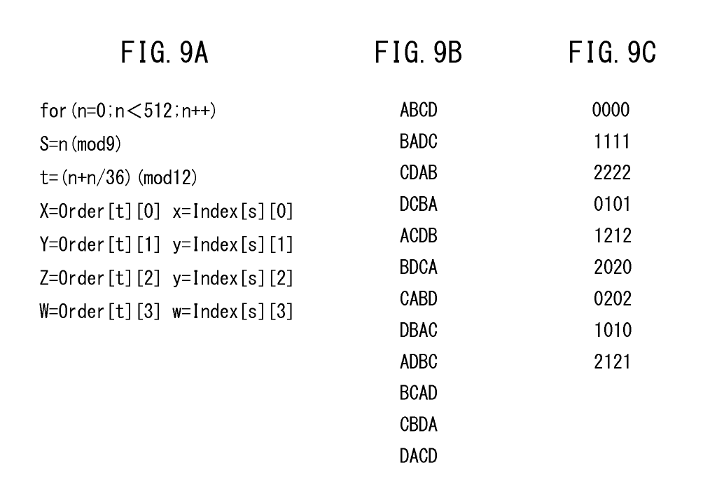

FIG. 9A is a diagram illustrating another selection algorithm. FIG. 9B is a diagram illustrating a first intermediate key selection table used in the selection algorithm illustrated in FIG. 9A and FIG. 9C is a diagram illustrating a second intermediate key selection table used in the selection algorithm illustrated in FIG. 9A.

The number of rows of the first intermediate key selection table illustrated in FIG. 9B is 12 and the number of rows of the second intermediate key selection table illustrated in FIG. 9C is 9, and the least common multiple of the two numbers of rows is 108. By the selection algorithm illustrated in FIG. 9A, it is possible to perform processing 512 times, the number of times being greater than the least common multiple of the two numbers of rows.

All examples and conditional language provided herein are intended for pedagogical purposes of aiding the reader in understanding the invention and the concepts contributed by the inventor to furthering the art, and are to be construed as limitations to such specifically recited examples and conditions, nor does the organization of such examples in the specification relate to a illustrating of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data scramble device comprising:
an intermediate key generation unit configured to generate intermediate keys from random numbers;
an extended key generation unit configured to generate an extended key from intermediate keys generated by the intermediate key generation unit; and
a scramble arithmetic operation unit configured to generate scramble data by performing a scramble arithmetic operation of target data and an extended key generated by the extended key generation unit.

2. The data scramble device according to claim 1, wherein
the intermediate key generation unit generates:
first arithmetic operation data by performing an arithmetic operation of the random number and a first fixed number;
second arithmetic operation data by performing an arithmetic operation of the random number and a second fixed number; and
a plurality of intermediate keys by repeating processing to generate an intermediate key by performing a scramble arithmetic operation of the first arithmetic operation data and the second arithmetic operation data a plurality of times while changing the first fixed number and the second fixed number.

3. The data scramble device according to claim 2, wherein
the extended key generation unit:
selects any of the plurality of intermediate keys by using an intermediate key selection table;
generates a plurality of unit extended keys from the selected intermediate keys; and
generates the extended key by combining the plurality of generated unit extended keys.

4. The data scramble device according to claim 3, comprising a first intermediate key selection table having a plurality of rows and a second intermediate key selection table having rows in the number different from the number of rows of the first intermediate key selection table, wherein
the number of combinations of the intermediate keys that can be selected by selecting rows of the first intermediate key selection table and the second intermediate key selection table is greater than the number of unit extended keys used when the extended key is generated.

5. The data scramble device according to claim 4, wherein
the least common multiple of the number of rows of the first intermediate key selection table and the number of rows of the second intermediate key selection table is greater than the number of unit extended keys used when the extended key is generated.

6. The data scramble device according to claim 4, wherein
the least common multiple of the number of rows of the first intermediate key selection table and the number of rows of the second intermediate key selection table is less than the number of unit extended keys used when the extended key is generated.

7. A security device comprising:
an intermediate key generation unit configured to generate intermediate keys from random numbers;
an extended key generation unit configured to generate an extended key from intermediate keys generated by the intermediate key generation unit;
a scramble arithmetic operation unit configured to decrypt encryption target data by performing a scramble arithmetic operation of scramble data and an extended key generated by the extended key generation unit; and
an encryption unit configured to encrypt encryption target data decrypted by the scramble arithmetic operation unit.

8. A security system comprising:
an encryption device; and
a host device including:
a random number generation unit configured to generate random numbers;
a first intermediate key generation unit configured to generate intermediate keys from random numbers generated by the random number generation unit;
a first extended key generation unit configured to generate an extended key from intermediate keys generated by the first intermediate key generation unit;
a first scramble arithmetic operation unit configured to generate scramble data by performing a scramble arithmetic operation of encryption target data and an extended key generated by the first extended key generation unit; and
a first transmission unit configured to transmit random numbers generated by the random number generation unit and scramble data generated by the first scramble arithmetic operation unit, and
the encryption device includes:
a second reception unit configured to receive random numbers and scramble data transmitted from the first transmission unit;
a second intermediate key generation unit configured to generate intermediate keys from random numbers received by the second reception unit;
a second extended key generation unit configured to generate an extended key from intermediate keys generated by the second intermediate key generation unit;
a second scramble arithmetic operation unit configured to decrypt encryption target data by performing a scramble arithmetic operation of scramble data received by the second reception unit and an extended key generated by the second extended key generation unit;
an encryption unit configured to encrypt encryption target data decrypted by the second scramble arithmetic operation unit; and
a second transmission unit configured to transmit encryption target data encrypted by the encryption unit.

9. A data scramble method comprising:
generating intermediate keys from random numbers;
generating an extended key from the generated intermediate keys; and
generating scramble data by performing a scramble arithmetic operation of target data and the generated extended key.
